(19) United States
(12) Patent Application Publication
(10) Pub. No.: US 2009/0160539 A1
(43) Pub. Date: Jun. 25, 2009

(54) Voltage reference circuit

(75) Inventors: Chi-Sung Hsieh, Hsinchu (TW); Yu-Hua Liu, Hsinchu (TW)

Correspondence Address: BIRCH STEWART KOLASCH & BIRCH, PO BOX 747, FALLS CHURCH, VA, 22040-0747, US

(73) Assignee: Airoha Technology Corp.

(21) Appl. No.: 12/078,768

(22) Filed: Apr. 4, 2008

(30) Foreign Application Priority Data
Dec. 20, 2007 (TW) 096148931

(51) Int. Cl. G05F 1/10

(52) U.S. Cl. 327/543

(57) ABSTRACT

A voltage reference circuit comprises a current mirror set, a first resistor, a first MOS transistor, and a second MOS transistor. The output end of the current mirror set is coupled to a first resistor, and the node of the current mirror set is coupled to the first MOS transistor, furthermore, the second MOS transistor is coupled to the first MOS transistor, and the first end and the gate of the second MOS transistor are coupled each other, such that a stable voltage reference will be obtained between the first MOS transistor and the second MOS transistor.

### FIELD OF THE INVENTION

The present invention relates to a voltage reference circuit, comprising a first Metal-Oxide-Semiconductor (MOS) transistor coupled to a current mirror set and a second MOS transistor for having a stable voltage reference obtained between the first MOS transistor and/or the second MOS transistor.

### BACKGROUND OF THE INVENTION

Referring to FIG. 1, a circuit diagram of a prior art in respect of a voltage reference circuit is showed. The voltage reference circuit 10 comprises a first N-type MOS (NMOS) transistor 111, a second NMOS transistor 113, a first P-type MOS (PMOS) transistor 131, a second PMOS transistor 133, a first resistor 15, a third PMOS transistor 135, a second resistor 171, and a bipolar transistor 173. The source of the second NMOS transistor 113 is connected to a negative voltage Vss through a first resistor 15, and the gate of the second NMOS transistor 113 is connected to the gate of the first NMOS transistor 111. Besides, the gate and the drain of the first NMOS transistor 111 are coupled each other, and the source of the first NOMS 111 is connected with the negative voltage Vss. Therefore, while a current has flowed through the first NMOS transistor 111, a corresponding mirror current I1 will be generated on the second NMOS transistor 113, and further the mirror current I1 will flow through the first NMOS transistor 113 and the first resistor 15.

The gate of the first PMOS transistor 131 is coupled to the gate of the second PMOS transistor 133, and the gate and the drain of the second PMOS transistor 133 are coupled each other, such that the drain of the second PMOS transistor 133 is coupled to the drain of the second NMOS transistor 113. The sources of the first PMOS transistor 131 and the second PMOS transistor 133 are coupled with a positive voltage VDD, and the drains of the first PMOS transistor 131 and the first NMOS transistor 111 are coupled each other.

Besides, the gate of the second PMOS transistor 133 is further coupled to the gate of the third PMOS transistor 135, therefore, another mirror current 12 will be generated on the third PMOS transistor 135. The drain of the third PMOS transistor 135 is coupled to the second resistor 171 and the bipolar transistor 173, thus, the mirror current I2 will flow through the second resistor 171 and the bipolar transistor 173, and a bias Vref will be provided between the second PMOS transistor 135 and the second resistor 171.

### SUMMARY OF THE INVENTION

It is a primary object of the present invention to provide a voltage reference circuit, which comprises a current mirror set, a first MOS transistor, and a second MOS transistor, wherein a first voltage output-end is provided between the first MOS transistor and the second MOS transistor to output a stable voltage reference accordingly.

It is a secondary object of the present invention to provide a voltage reference circuit, wherein the second MOS transistor is coupled to at least one MOS transistor, such that the voltage reference circuit can be with multiple voltage output ends to output a plurality of different voltage references respectively.

It is another object of the present invention to provide a voltage reference circuit, wherein the second MOS transistor is coupled to a load unit, such that the voltage reference circuit can provide a plurality of different voltage references.

It is another object of the present invention to provide a voltage reference circuit, wherein the current mirror set is coupled to an enabling unit for enabling the current mirror set.

To achieve the previous mentioned objects, the present invention provides a voltage reference circuit, comprising: a current mirror set, comprising an output end and a node; a first resistor connected to the output end of the current mirror set; a first MOS transistor, the gate of which is coupled to the node of the current mirror set; a second MOS transistor coupled to the first MOS transistor, and the first end and the gate of the second MOS transistor being coupled; and a first voltage output end provided between the first MOS transistor and second MOS transistor for outputting a voltage reference.

### BRIEF DESCRIPTION OF THE DRAWINGS

The above-mentioned and other features and advantages of this invention, and the manner of attaining them, will become apparent and be more completely understood by reference to the following description of one embodiment of the invention when read in conjunction with the accompanying drawings, wherein:

FIG. 1 illustrates a voltage reference circuit diagram according to a prior art;

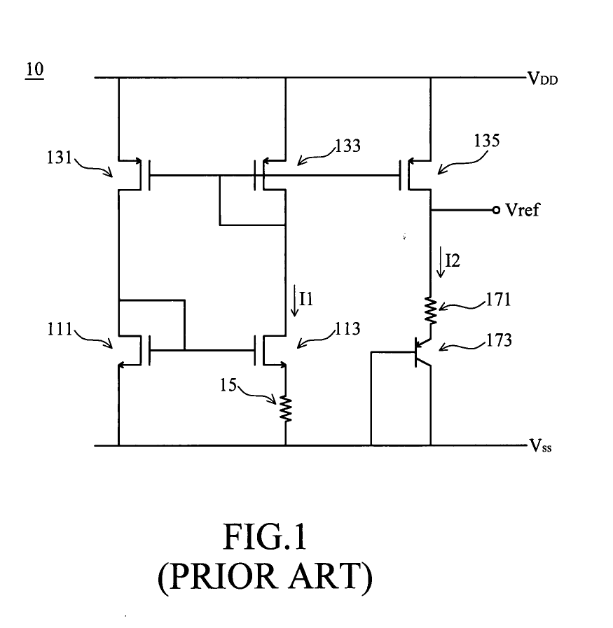

FIG. 2 illustrates a voltage reference circuit diagram of a preferred embodiment according to the present invention;

FIG. 3 illustrates a relation chart that shows the relation between the voltage reference and the temperature according to the voltage reference circuit shown on FIG. 2;

FIG. 4 illustrates a voltage reference circuit diagram of another preferred embodiment according to the present invention;

FIG. 5 illustrates a relation chart that shows the relation between the voltage reference and the temperature according to the voltage reference circuit shown on FIG. 4;

FIG. 6 illustrates a voltage reference circuit diagram of another preferred embodiment according to the present invention; and

FIG. 7 illustrates a voltage reference circuit diagram of another preferred embodiment according to the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

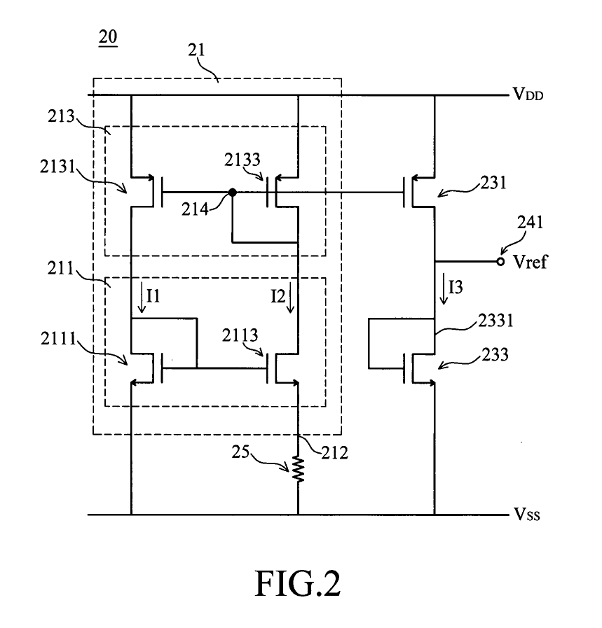

Referring to FIG. 2, a voltage reference circuit diagram of a preferred embodiment according to the present invention is disclosed. The voltage reference circuit 20 comprises a current mirror set 21, a first resistor 25, a first MOS transistor 231 and a second MOS transistor 233. The current mirror set 21 comprises an output end 212 and a node 214, wherein the output end 212 of the current mirror set 21 is coupled to the first resistor 25, and the node 214 thereof is coupled to the gate of the first MOS transistor 231.

The first MOS transistor 231 is coupled to a second MOS transistor 233, and the first end 2331 and the gate of the second MOS transistor 233 are coupled each other, such as while the second MOS transistor 233 is an enhancement type MOS transistor, the drain and the gate of which will be coupled. A first voltage output end 241 is provided between the first MOS transistor 231 and the second MOS transistor 233, for example, a voltage output end 241 is provided on the first end 2331 of the second MOS transistor 233 to output a stable voltage reference Vref.

There are various different types of the current mirror; therefore, users will determine different types of the current mirror depending on the demand of the circuit generally. Regarding to the present invention, a preferred type of the current mirror is showed as FIG. 2. The current mirror set 21 comprises at least one current mirror unit, such as the first current mirror unit 211 and the second current mirror unit 213. The first current mirror unit 211 comprises a third MOS transistor 2111 and a fourth MOS transistor 2113, wherein the gate of the third MOS transistor 2111 and the fourth MOS transistor 2113 are coupled each other, and the gate and the drain of the third MOS transistor 2111 are coupled. The second current mirror unit 213 is connected to a positive voltage VDD, comprising a fifth MOS transistor 2131 and a sixth MOS transistor 2133, wherein the gate of the fifth MOS transistor 2131 and the sixth MOS transistor 2133 are coupled each other, and the gate and the drain of the fifth MOS transistor 2131 are coupled.

In accordance with the present embodiment, the third MOS transistor 2111 and the fourth MOS transistor 2113 of the first current mirror unit 211 are the same type MOS transistor, such as the N-type MOS transistor. The fifth MOS transistor 2131, the sixth MOS transistor 2133, and the first MOS transistor 231 are the same type MOS transistor, such as P-type MOS transistor.

The first current I1 and the second current I2 respectively flows through the fifth MOS transistor 2131 and the sixth MOS transistor 2133 in practice, and a third current 13 can be provided on the first MOS transistor 231 accordingly. The ratio among the first current I1, the second current I2, and the third current I3 is depending on the determination of the width (W) and the length (L) of the first MOS transistor 231, the fifth MOS transistor 2131, and/or the sixth MOS transistor 2133, for example, while the first MOS transistor 231, the fifth MOS transistor 2131, and the sixth MOS transistor 2133 are the same type MOS transistor, the values of the first current I1, the second current I2, and the current I3 will be the same. Furthermore, users also can determine the third MOS transistor 2111 and the fourth MOS transistor 2113 for regulating the values of the first current I1 and the second current I2.

The value of the voltage reference Vref can be depending on the determinations of the first MOS transistor 231, the second MOS transistor 233, the third MOS transistor 2111, the fourth MOS transistor 2113, the fifth MOS transistor 2131, the sixth MOS transistor 2133, and/or the first resistor 15, for further application thereof.

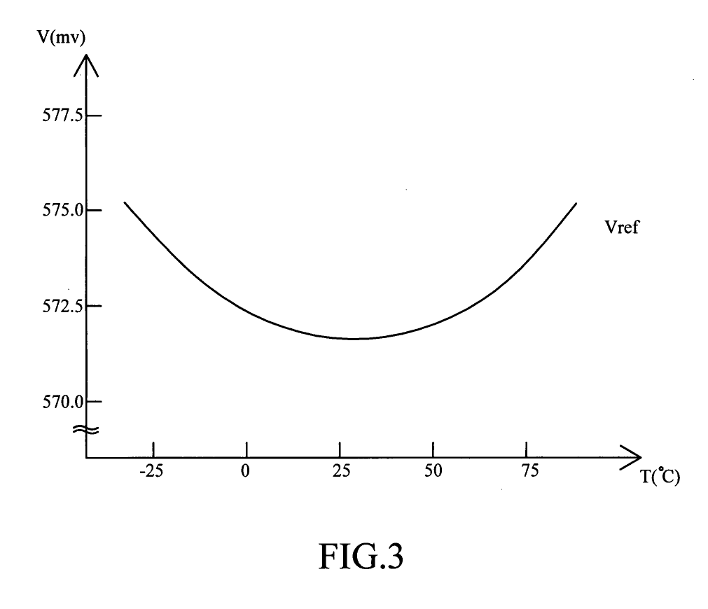

Referring to FIG. 3, a relation chart that shows the relation between the voltage reference and the temperature according to the voltage reference circuit shown on FIG. 2 is disclosed, as well as, referring to FIG. 2 correspondingly. The relations between the current ID of the MOS transistor and other parameters are showed as following:

$$\begin{matrix}{I}_{D} = \frac{1}{2} {μ}_{n} {C}_{ox} \frac{W}{L} {( {V}_{GS} - {V}_{TH} )}^{2} \\ ⇒ {V}_{GS} = \sqrt{\frac{2 {I}_{D}}{{μ}_{n} {C}_{ox} W / L}} + {V}_{TH} \\ since {V}_{GS 3} = {V}_{GS 4} + {I}_{2} R \\ if {I}_{1} = {I}_{2} = {I}_{3} , {( \frac{W}{L} )}_{4} = {{K}_{1} ( \frac{W}{L} )}_{3} , and {( \frac{W}{L} )}_{2} = {{K}_{2} ( \frac{W}{L} )}_{3} \\ then \\ {I}_{3} = {I}_{2} = \frac{{V}_{GS 3} - {V}_{GS 4}}{R} ≅ \sqrt{\frac{2 {I}_{D}}{{R}^{2} {μ}_{n} {{C}_{ox} ( W / L )}_{3}}} - \sqrt{\frac{2 {I}_{D}}{{R}^{2} {μ}_{n} {C}_{ox} {{K}_{1} ( W / L )}_{3}}} = \sqrt{\frac{2}{{R}^{2} {μ}_{n} {{C}_{ox} ( W / L )}_{3}}} \cdot ( 1 - \frac{1}{\sqrt{{K}_{1}}} ) \cdot \sqrt{{I}_{D}} \\ since {I}_{3} = {I}_{D} \\ given \sqrt{{I}_{3}} = \sqrt{\frac{2}{{R}^{2} {μ}_{n} {{C}_{ox} ( W / L )}_{3}}} \cdot ( 1 - \frac{1}{\sqrt{{K}_{1}}} ) & \\ {I}_{3} = \frac{2}{{R}^{2} {μ}_{n} {{C}_{ox} ( W / L )}_{3}} \cdot {( 1 - \frac{1}{\sqrt{{K}_{1}}} )}^{2} & ( 1 ) \\ {V}_{ref} = {V}_{GS 2} = \sqrt{\frac{2 {I}_{3}}{{μ}_{n} {{C}_{ox} ( W / L )}_{2}}} + {V}_{TH 2} = \sqrt{\frac{2 {I}_{3}}{{μ}_{n} {C}_{ox} {{K}_{2} ( W / L )}_{3}}} + {V}_{TH 2} & ( 2 )\end{matrix}$$

substituting the formula (1) into the formula (2), given

$${V}_{ref} = \frac{1}{\sqrt{{K}_{2}}} \cdot ( 1 - \frac{1}{\sqrt{{K}_{1}}} ) \cdot \frac{2}{{R}^{2} {μ}_{n} {{C}_{ox} ( W / L )}_{3}} + {V}_{TH 2} \qquad ( 3 )$$

According to the foregoing inference, the relationships between the voltage reference Vref and other parameters can be given, and further, the formula (3) can be simulated accordingly for inferring the relation chart that shows the relation between the voltage reference Vref and the temperature, as shown on FIG. 3. While the voltage reference circuit 20 is operated under the temperature between −40 to 85 degrees centigrade, the value of the corresponding voltage reference Vref generated by the voltage reference circuit 20 will be around 570 mv to 575 mv, in other words, the voltage reference Vref will not be altered substantially according to the alteration of the temperature.

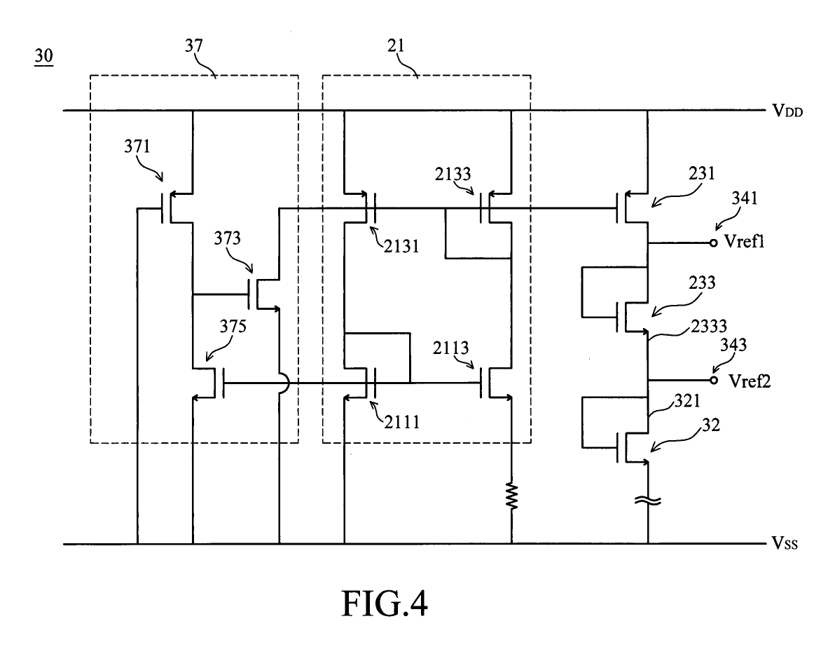

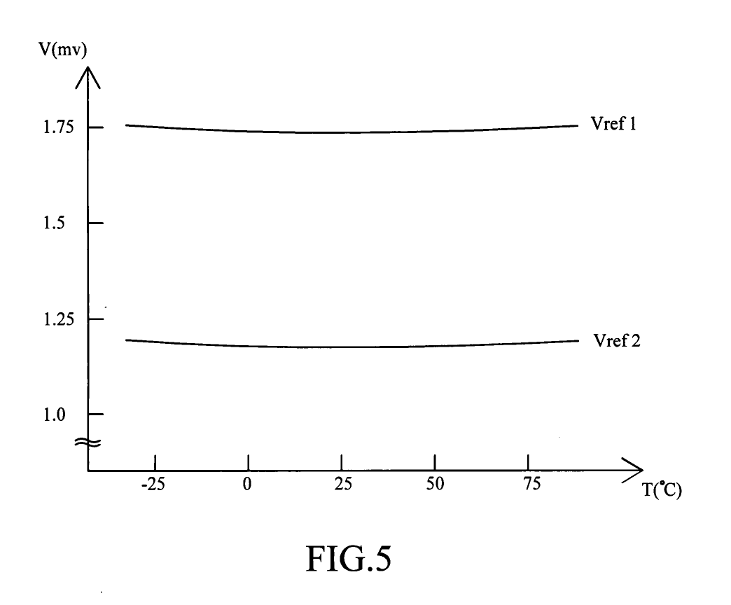

Referring to FIG. 4 and FIG. 5, the voltage reference circuit 30 comprises a current mirror set 21, a first MOS transistor 231, a second MOS transistor 233, and at least one MOS transistor 32, as shown on FIG. 4. Regarding to FIG. 5, the relation chart shows the relationship between the temperature and the voltage reference, such as Vref1 and Vref2, generated by the voltage reference circuit 30; correspondingly, the simulation process is the same with the embodiment shown on FIG. 3. Therefore, the voltage reference circuit 30 can generate stable voltage references Vref1 and Vref2 in accordance with the illustration of the relation chart.

Furthermore, in practice, at least one MOS transistor 32 can be provided on the second end 2333 of the second MOS transistor 233, and the first end 321 and the gate of the MOS transistor 32 are coupled each other, such that the voltage reference circuit 30 can provide a plurality of different voltage references. For example, the voltage reference circuit 30 comprises a first voltage output end 341 and a second voltage output end 343, wherein the first voltage output end 341 is provided between the first MOS transistor 231 and the second MOS transistor 233 for outputting the first voltage reference Vref1, and the second voltage output end 343 is provided between the second MOS transistor 233 and the MOS transistor 32 for outputting the second voltage reference Vref2, furthermore, the value of which can be different from the first voltage reference Vref1.

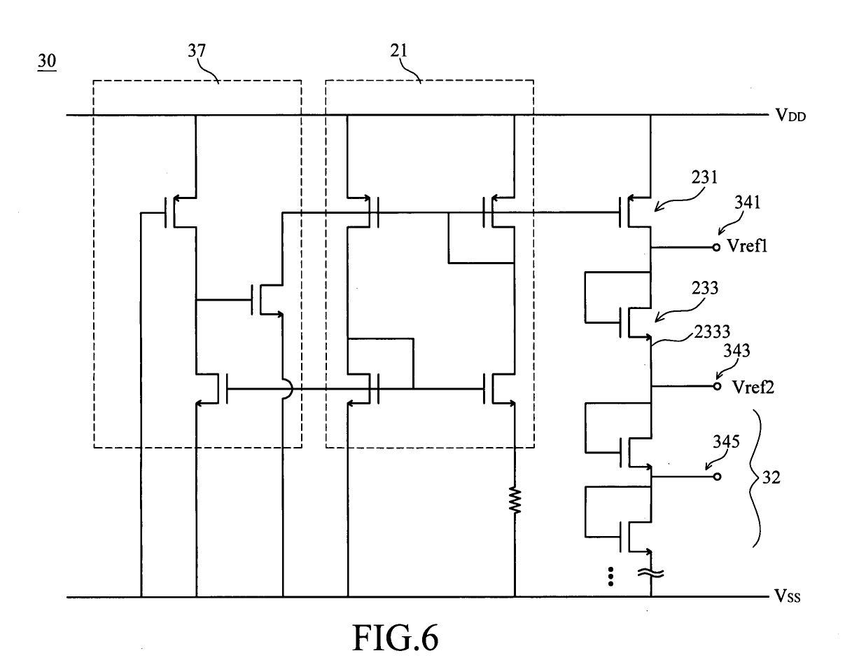

The second MOS transistor 233 can be coupled to a plurality of MOS transistors 32 also, according to other embodiments, as shown on FIG. 6. The voltage reference circuit further comprises other voltage output ends 345 provided between two adjacent MOS transistors 32 for outputting various different voltage references, except the first voltage output end 341 and the second voltage output end 343.

Furthermore, the voltage reference circuit 30 further comprises an enabling unit 37 connected to the current mirror set 21, for example, the enabling unit 37 can comprise a seventh MOS transistor 371, a eighth MOS transistor 373, and a ninth MOS transistor 375. The enabling unit 37 is used for enabling the current mirror set 21, for example, the enabling unit 37 supplies the bias to the MOS transistors 2111, 2113, 2131, and 2133 of the current mirror set 21, such that the MOS transistors 2111, 2113, 2131, and 2133 can be performed under the saturation area or the triode area.

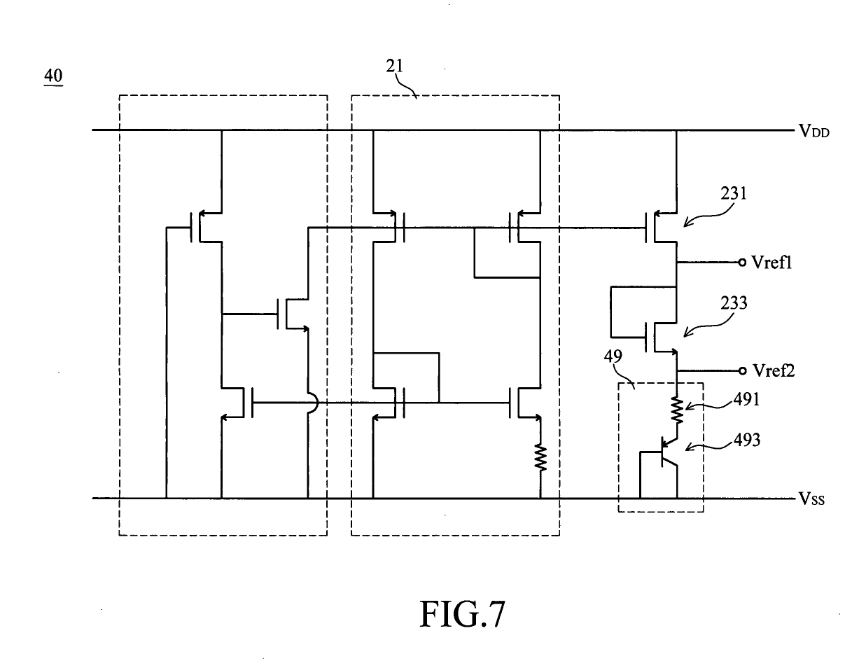

Referring to FIG. 7, a voltage reference circuit diagram of another preferred embodiment according to the present invention is disclosed. The voltage reference circuit 40 comprises a current mirror set 21, a first MOS transistor 231, a second MOS transistor 233, and at least one load unit 49, wherein the load unit 49 that comprises a second resistor 491 and a semiconductor element 493 connected in series is coupled to the second MOS transistor 233.

In accordance with the present embodiment, the semiconductor 493 is a bipolar transistor, and further, which could be a MOS transistor or diode in practice. Otherwise, a plurality of MOS transistors can be provided between the load unit 49 and the second MOS transistor 233 for having a plurality of different voltage references, certainly, at least one MOS transistor, such as the MOS transistor shown on FIG. 6, can be provided between the load unit 49 and the second MOS transistor 233 for having more different voltage references.

While the present invention has been described as having a preferred design, the invention can be further modified within the spirit and scope of this disclosure. This disclosure is therefore intended to encompass any equivalents to the structures and elements disclosed herein. Further, this disclosure is intended to encompass any variations, uses, or adaptations of the present invention that use the general principles disclosed herein. Moreover, this disclosure is intended to encompass any departures from the subject matter disclosed that come within the known or customary practice in the pertinent art and which fall within the limits of the appended claims.

I claim:

1. A voltage reference circuit, comprising:
a current mirror set, comprising an output end and a node;
a first resistor connected to the output end of said current mirror set;
a first MOS transistor, the gate of which is coupled to the node of said current mirror set;
a second MOS transistor coupled to said first MOS transistor, and the first end and the gate of said second MOS transistor being coupled; and
a first voltage output end provided between said first MOS transistor and second MOS transistor for outputting a voltage reference.

2. The voltage reference circuit of claim 1, wherein said current mirror set comprises at least one current mirror unit.

3. The voltage reference circuit of claim. 1, wherein said current mirror set comprises a first current mirror unit and a second current mirror unit.

4. The voltage reference circuit of claim 3, wherein said first current mirror unit comprises a third MOS transistor and a fourth MOS transistor, and said second current mirror unit comprises a fifth MOS transistor and a sixth MOS transistor.

5. The voltage reference circuit of claim 4, wherein said first MOS transistor, said fifth MOS transistor, and said sixth MOS transistor are the same type MOS transistor.

6. The voltage reference circuit of claim 1, further comprising at least one MOS transistor connected to the second end of said second MOS transistor.

7. The voltage reference circuit of claim 6, wherein the first end and the gate of said MOS transistor are coupled.

8. The voltage reference circuit of claim 6, wherein a second voltage output end is provided between said second MOS transistor and said MOS transistor.

9. The voltage reference circuit of claim 6, wherein the number of said MOS transistor are a plurality, and a voltage output end is provided between two adjacent MOS transistors.

10. The voltage reference circuit of claim 1, further comprising at least one load unit coupled to said second MOS transistor.

11. The voltage reference circuit of claim 10, wherein said load unit comprising a second resistor and a semiconductor element connected in series.

12. The voltage reference circuit of claim 10, wherein said semiconductor element can be one of a MOS transistor, a diode, or a bipolar transistor.

13. The voltage reference circuit of claim 10, wherein at least one MOS transistor is provided between said second MOS transistor and said load unit.

14. The voltage reference circuit of claim 1, further comprising an enabling unit connected to said current mirror set.
